(19) United States
(12) Patent Application Publication
(10) Pub. No.: US 2013/0054346 A1
(43) Pub. Date: Feb. 28, 2013

(54) PROVIDING HIPPA COMPLIANT TARGETED ADVERTISING TO PATIENT

(71) Applicant: Ronald D. SEKURA, Key Largo, FL (US)

(72) Inventor: Ronald D. SEKURA, Key Largo, FL (US)

(21) Appl. No.: 13/595,698

(22) Filed: Aug. 27, 2012

Related U.S. Application Data
(60) Provisional application No. 61/527,862, filed on Aug. 26, 2011.

(51) Int. Cl. G06Q 30/02

(52) U.S. Cl. 705/14.39; 705/14.66

(57) ABSTRACT

A method for providing HIPAA and HITECH compliant targeted advertising to patients. The method including receiving information for posting and target audience criteria from a client entity, identifying, without disclosing any medical information to the client entity, a subset of patients which meet the received target audience criteria by searching the medical records of the plurality of patients, processing the information for the subset of patients, generating and sending an electronic message to the subset of patients identified by the identifying, which notifies the subset of patients that an opportunity exists and is accessible via a website, without specifically identifying the opportunity and in response to the completion of the processing, displaying a portion of the information to each of the subset of the patients which logs into the website and enabling a second portion of the information to be accessed in response to a selection on the website.

### CROSS-REFERENCE TO RELATED APPLICATIONS

This application is based upon and claims the benefit of priority under 35 U.S.C. §119(e) from U.S. Ser. No. 61/527,862, filed Aug. 26, 2011, the entire contents of which are incorporated herein by reference.

### BACKGROUND

Advertising, promotions, and providing information to patients targeted on the basis of medical information is restricted by the Health Insurance Portability Accountability Act of 1996 (“HIPAA”) and Health Information Technology for Economic and Clinical Health Act (“HITECH Act”) regulations, and state and local regulations. As a result, there are very few examples of targeted advertising in the medical world.

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

### SUMMARY OF THE INVENTION

In one embodiment of the present invention, there is provided a method for providing advertising, compliant with government regulations such as HIPPA and the HITECH Act, to patients and other individuals. In the method there is included the steps of receiving information for posting and target audience criteria from a client entity, identifying, without disclosing any patient information to the client entity, a subset of patients which meet the received target audience criteria by searching medical records of the plurality of patients, processing the information for the subset of patients identified by the identifying, generating and sending an electronic message to the subset of patients identified by the identifying, which notifies the subset of patients that an opportunity exists and is accessible via a website, without specifically identifying the opportunity and in response to the completion of the processing, displaying a portion of the information to each of the subset of the patients which logs into the website and enabling a second portion of the information to be accessed in response to a selection on the website.

The aforementioned and other aspects, features and advantages will be more fully apparent from the following detailed description of illustrative embodiments, the accompanying drawings and the associated claims.

### BRIEF DESCRIPTION OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIG. 1 illustrates a system according to one embodiment of the present invention including a user device, a client entity and a server/database;

FIG. 2 illustrates an example of a login screen for a patient or medical provider accessible website provided by the server;

FIG. 3 illustrates an example of the website interface which is accessed by the patient or a party providing patient care;

FIG. 4 illustrates an example of a patient information page of the website interface;

FIG. 5 illustrates a refill setup screen;

FIG. 6 illustrates an example of a selection criteria of a particular patient subset;

FIG. 7 illustrates the main website interface with the addition of refill status;

FIG. 8 illustrates a flow chart of a method according to one embodiment of the invention; and

FIG. 9 illustrates an exemplary computer according to one embodiment of the present embodiments of the invention.

### DESCRIPTION OF THE EMBODIMENTS OF THE INVENTION

A description is now given of illustrative embodiments. It should be noted that although such terms as first, second, etc. may be used herein to describe various elements, components, and/or sections, it should be understood that such elements, components, and/or sections are not limited thereby because such terms are relative, that is, used only to distinguish element, component, or section from one another. Thus, for example, a first element, component, or section discussed below could be termed a second element, component, or section without departing from the teachings of this disclosure.

In addition, it should be noted that the terminology used herein is for the purpose of describing particular embodiments only and is not intended to be limiting of this disclosure. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, steps, operations, elements, and/or components, but do not preclude the presence or addition of one or more other features, steps, operations, elements, components, and/or groups thereof.

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

In a later-described comparative example, illustrative embodiment, and alternative example, for the sake of simplicity, the same reference numerals may be given to constituent elements such as components having the same functions, and redundant descriptions thereof omitted.

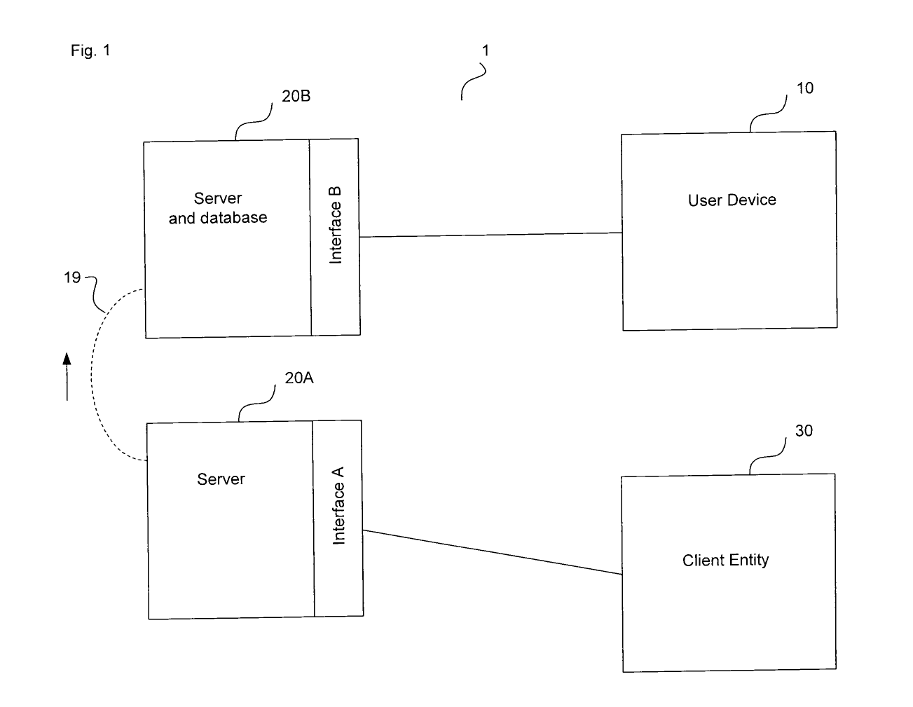

Referring now to the drawings, wherein like reference numerals designate identical or corresponding parts throughout the several views, and initially with reference to FIG. 1, a description is provided of an medical privacy compliant advertising system according to an aspect of this disclosure.

As is noted above, advertising, promotions, and providing information to patients targeted on the basis of medical information is restricted by HIPAA and HITECH Act regulations.

Thus, illustrated in FIG. 1 is a system 1, such as the HipCAd system provided by Nexdose, that operates within the constraints imposed by regulations and facilitates pharmaceutical manufacturers, care and service providers, insurers or third party payers, organizations, and other entities the opportunity to provide valuable information and promotions to patients while maintaining compliance with HIPAA and HITECH Act and other government privacy regulations.

FIG. 1 illustrates a server 20B which is connectable by a user device 10 via an interface B and a server 20A which is connectable to client entity 30 (e.g. pharmaceutical manufacturers, care and service providers, insurers or third party payers, organizations, and other entities) via interface A. The user device 10 and the client entity 30 connect to the system servers 20A and 20 B via a network such as the Internet or via an intranet. The network may also be wired, wireless, or any other suitable type of communications network.

The client entity 30, which connects to server 20A, has no access to the database or medicinal records of the patients housed in server 20B.

The system 1 provides advantageous benefits to patients who, because of the rigors of HIPAA and the HITECH Act and other government privacy regulations, would otherwise be deprived of medically valuable information or financial benefits from promotions and other opportunities provided by client entities.

The system 1 enables enrollment of patients into a secure HIPAA compliant service in server 20B, which houses the patient's medication therapy records in a database. The database may also alternatively be located remote from the server 20B.

Link 19 is a one way link that enables information received at the server 20A to be transmitted to the server 20B for use in generating opportunities.

In addition, in an alternate embodiment, Server 20A and Sever 20 B could be the same server. In this instance, interface B and interface A are isolated such that the client entity has no access to the information or records of the patients.

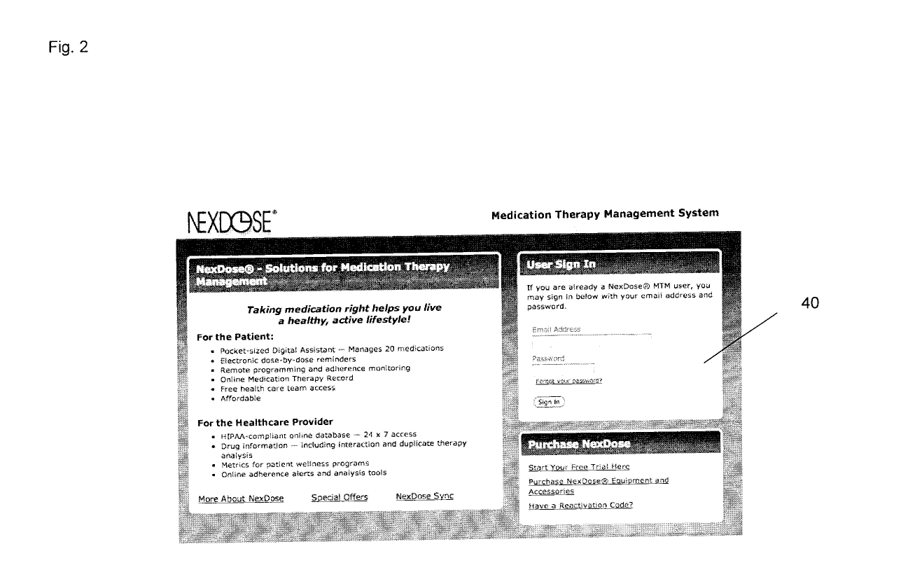

To access information, patients, via user device 10, for example, log into the site using a user name (e.g. an e-mail address) and pass code. The user interface to the server 20B may be via a website such as NexDoseMTM.com which is an example of such a website. FIG. 2 illustrates a log-in screen which may be provided by server 20B. The user sign-in section 40 provides a portal for patients.

Patients and client entities log into or access servers 20B or 20A, respectively. However, the resulting web or network interfaces are different (e.g. interface A and B shown in FIG. 1) for these entities.

The client entities are given the option to upload information pertaining to products, services, etc. and are given the opportunity to indicate or select from different patient target groups. At no time will the client entity have access to any information about the patients that are enrolled in the system 1. The information from the client entities can also be submitted to the server 20A via email, other electronic communication or other common means of communication to system 1 administrators and support staff.

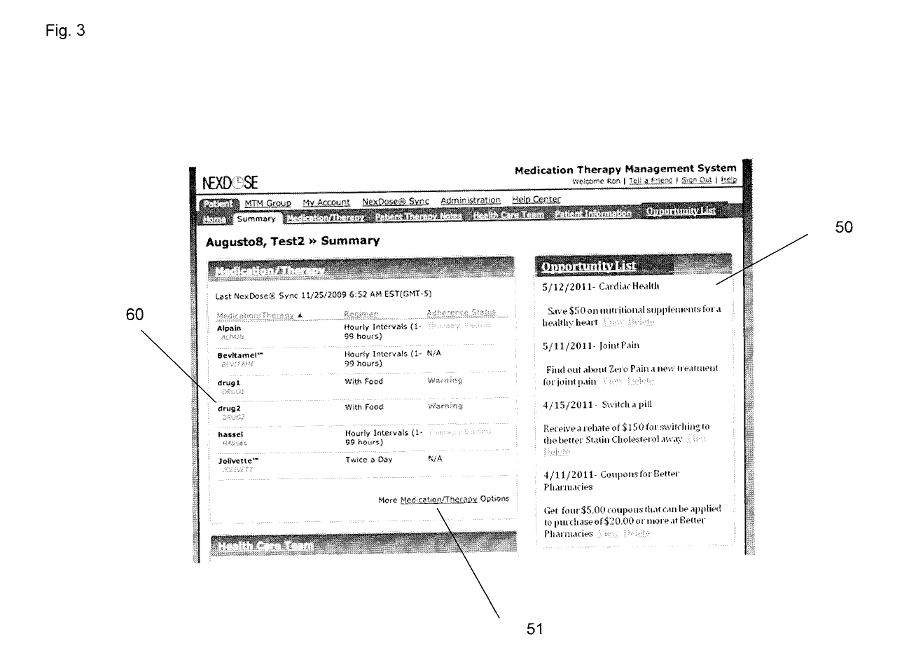

FIG. 3 illustrates an example of the website interface B of server 20B which is accessed by the patients.

The exemplary web-based service implemented by the server 20B acts not only as a reservoir for the medical records of the patient but also provides numerous other features such as drug-and-drug interaction information, wizards for planning medication schedules, tools to facilitate refills, the ability to generate paper calendars showing medical schedules, the ability to program digital devices, smart phones, tablets and other electronic devices that provide dosing alerts, and monitoring capacity that tracks the level of patient adherence to therapy.

These features and other features create an inducement for patients to house their medical records, such as medication therapy records, on the website of the server 20B. The present system 1 (e.g. the HipCAd system or Medication Therapy Management System) can provide a significant enhancement to these services noted above which are provided by the website of the server 20B.

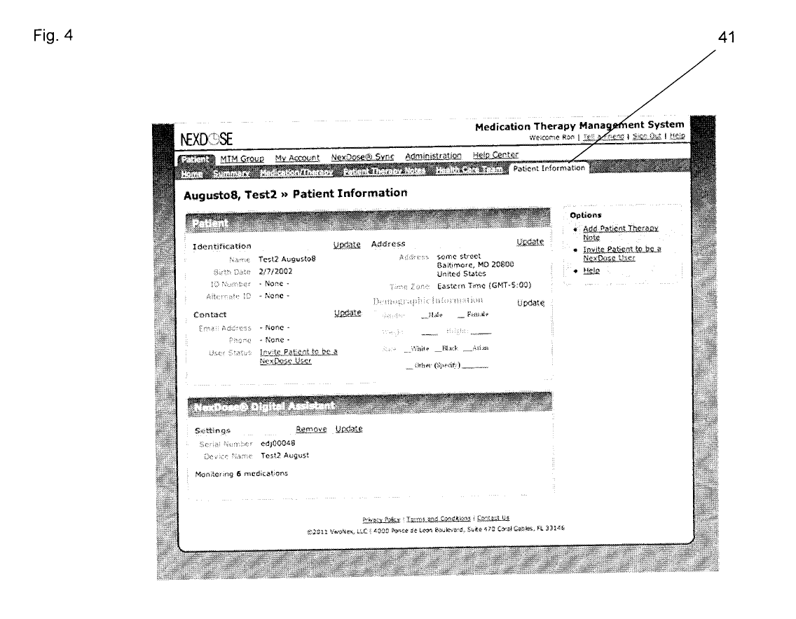

FIG. 4 is an example of the patient information page 41. This page provides the patient with the ability to update profile information. This is information is initially completed during sign up. The patient information page 41 also enables the addition of digital assistant device information. This device is utilized in the medical therapy compliance/adherence tracking process. Further details regarding the compliance tracking process is found in U.S. Pat. No. 7,945,461, herein incorporated by reference.

In order to access the information of the patient, the system and the administrating organization must have permission to access to the information contained in the patient data files. The patient will be requested to agree to terms similar to those presented in Table A1.

TABLE A1
Privacy Policy: We will not share your personal information with any third
parties, with the exception of those individuals and healthcare providers
you invite to be members of your healthcare team.
Conditions for use of Save-U-Med: We will use the information you
provide to this site to identify opportunities which we believe may be of
medical or financial value to you. These opportunities can only be viewed
by your logging into your secure Save-U-Med account. From time to time
we will send you e-mails alerting you of these opportunities. We may
occasionally alert you if the information provided indicates it is time to
refill a prescription. We will protect your personal information in
accordance with our privacy policy.

Once the patient authorizes the administrating organization in this way, the system will have access to relevant medical records of the patient. The system is then able to provide the patient with access to offers and information which would otherwise not be available to the patients.

In one example, a pharmacy group “First Pharmacies” could become a client entity. First Pharmacies may provide the option for a $5.00 off coupon on any purchase of $20 or more at Better Pharmacy. This example is illustrated in FIG. 3 in the right column. This offer could be provided to the system 1 via server 20A without including any specific patient target information. Alternatively, the target information could be based on some generic criteria such as location e.g. all patients which live within 50 miles of the Better Pharmacy or patients which log on to the system the most often.

More targeted dissemination of promotions and information may be achieved by client entities requesting offers be provided to patients on the basis of the medications they do or do not use (or are prescribed) and other delineators including but not limited to age or birth date, gender, height, weight, a geographic identifier such as zip code, levels of adherence to therapy, race, vital signs data, and medical diagnosis.

Once the information or offer to be provided is received along with target information at the server 20A, this information is transmitted to server 20B and is used to select patients.

The system 1 provides an administrator of the system 1 the ability to search the database for patients using medication names, NDC numbers, or other identifiers as the selection criteria. These searches are performed via a web interface of the server 20B which is accessible to an administrator who also has access to the information received by server 20B. The search is performed within the confines of the system 1 to ensure privacy of patient information and HIPAA compliance.

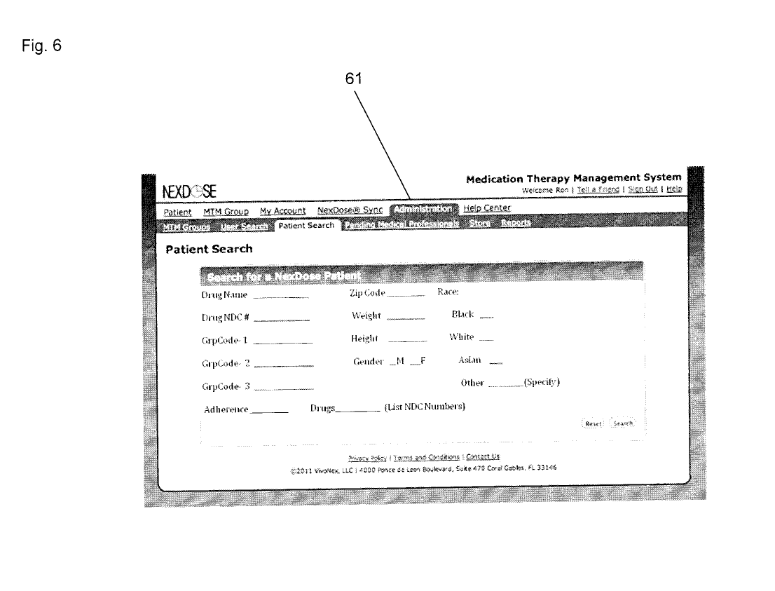

The website interface illustrated in FIG. 6 represents the interface which is accessed by the administrator. In the examples, illustrated in FIGS. 3-6 many of the options are shown. However, depending on the security permissions of the system, certain user tabs such as the administration tab 61 shown in FIG. 6 will not be provided to the patient interface. Instead, other tabs such as Preferred Pharmacy, Patient Search, or others may be shown.

The search enables the selection of patients meeting the specified criteria. FIG. 6 illustrates an example of a selection of a particular patients by the administrator of the system 1. FIG. 6 further illustrates a search field for identifying patients which meet certain criteria.

This search and identification process may also be automated and performed on a rolling basis.

In one embodiment, the information received by server 20A is accessed by the administrator and is used for a manual search for patients meeting certain criteria. Alternatively, in another embodiment, the information received by the server 20A is automatically transmitted to server 20B via link 19 and is published to selected patients on a rolling basis after approval by the administrator. For example, if a client entity submits information for Drug A and includes target information “All patients taking Drug B.” This information could be transmitted to server 20B which uses this information to automatically search for patients taking Drug B. The resulting list of patients and the information to be published to these patients could then be presented to the administrator for approval. The administrator would then simply be able to approve the publication and the information will be published to the account of each user on the list.

Once patients are identified manually or automatically and the publication of the listing is approved or the publication is posted, an e-mail, text messages or other forms of notification may be sent to the selected patients alerting the patients of a special opportunity but not providing medical condition identifying information in the message.

An example of an email which could be sent to selected patients is shown in Table A2 below.

TABLE A2
From: NexDose@nexdose.com
Subject: Valuable information about your healthcare
Date: August 22, 2011 9:25:05 AM EDT
To: Agusto8@anysite.com
Dear Agusto8,
We have posted information in your file that may pertain to improving
your health and that may offer significant financial advantage.
Sign on to your NexDose account for more information. NEXDOSE LINK
Thank you,
The NexDose Team
Working to provide you with better health options

The patient is invited to log into the secure server 20B either by the email or some other means such as a text, etc. Once the patient has logged into the server 20B, the patient will be presented with a number of opportunities (see Opportunity List in FIG. 3) or information. With regard to selectable opportunities, the user has the option of selecting and using the opportunity or rejecting the opportunity. Absent the e-mail invitation, the patient will also see the information when logging onto the site on the server 20B.

As an example, after receiving a coupon for Statin Cholesterol Away from a client entity, an administrator could manually or automatically perform a search for “Statin X.” In response, the system could automatically or in response to manual input by the administrator send the subset of patients, which match the search Statin X, an e-mail the states: “Check you HipCAd Account. There is a special offer that can save you $150.00.”

The patient would thus be prompted to log in and see an offer for “Statin Cholesterol Away.” The patient, by clicking a link, is taken to a page that provides a coupon for $150.00 (printable or alternatively electronic). The page may also include additional information. In this example, all of the information, including the coupon, is resident on the server 20B. This ensures that the information protected by HIPAA remains confidential.

Alternatively the promotional link could go to an outside site, such as, for example the website of the maker of Statin Cholesterol Away. Under this circumstance, the patient would be warned that using the link could potentially violate their privacy by exposing their IP address or they may be subject to the download of cookies on their computer. In this instance, the patient is presented an opt-in dialog box which allows verification of their desire to get additional information resident on a third party server or the option to reject the offer.

Several of the different types of offers and opportunities that can be presented to patients are shown in 50 of FIG. 3.

Alternative criteria for patient inclusion in a search result includes selection on the basis of a specific medication and the level of adherence to therapy achieved by monitoring or selection solely on the basis of adherence levels, with possibly further narrowing of selection based on association with a third party payer, health care provider, group, or other entity. Using these criteria, the system is able to provide incentives or awards to patients meeting or exceeding target adherence thresholds. For example, patients that have a high adherence level could be provided with discounts or other awards. Awards are provided by any of a number of methods including payment to an account held by the patient with PayPal™, a store credit account, a bank account, check, coupons, or direct premium reductions with an insurer.

Adherence monitoring is accomplished by monitoring patient refills or using a digital monitoring device that inputs adherence data into the patient record coupled with software logic that evaluates attainment of target adherence levels.

These features of the embodiments of the invention provide significant advantages especially when it is recognized that an estimated $300 billion is lost by patients not being adherent to medication therapy.

With the exception of links to outside sites, all of the information identifying specific patients with personal information is conducted within the confines of the secure server 20B or the secure server 20B and database. Access to personal information is only allowed when the patient or an authorized administrator or provider specifically attached to the patient's health care team, logs into the system 1 using a user name and pass code.

E-mail or other communication to the patient is performed to alert the patient that an opportunity of value is posted associated within their medication therapy or their account.

The server 20B is protected by firewall technologies and patient communications with the server 20B are protected by encryption and protocols such as https. If patients desire to follow a link to a site not provided by the server 20B, a warning is provided that following the link will result in leaving the security provided by the system 1.

Clients using the above method for advertising to patients or providing patients with information are billed on the basis of usage. Counters are able to track posted announcements (as is described below, each post is provided a unique tracking number) for any of:
the number of patient accounts to which the post has been disseminated;
number of days the post is displayed;
the aggregate patient-days of display;
the number of instances in which the post is viewed;
the number of instances where the post is printed; and
the number of instances where transfer is made to a link outside the server 20B.

Sponsor entities are clients which desire to provide patients with the services that the HipCAD system provides. However, at no time will sponsor entities have access to confidential information of patients unless the patient or responsible party allows the sponsor to become a member of the patient health care team. Patients, when registering into the system, may be asked to provide code that associates them to a specific sponsor group or promotion (GpCode). This GpCode is used to facilitate business exchanges between outside groups and the system 1. This can include revenue transfer in either direction depending on the nature business relation, and also may include a mechanism for associating patients with special information or opportunities associated with the GpCode. The business transactions are facilitated by implementation of the data collected by counters described in more detail below.

The GpCode arrangement may require that the system 1 provide a commission for revenues collected in association with a particular GpCode. Alternatively, special services can be directed to patients registered under the GpCode and the system 1 will be remunerated.

Counters track posted announcements (as described below, each post is provided a unique tracking number) for:

the number of patient accounts to which the post has been disseminated;

number of days the post is displayed;

the aggregate patient-days of display;

the number of instances in which the post is viewed;

the number of instances where the post is printed; and

the number of instances where transfer is made to a link outside the server 20B. Each of the counters also tracks the specific GpCode associated with the patient.

These counts are used to bill clients and sponsor entities which use the system 1 to provide information of promotions, and, as noted above, are used to facilitate business relations between the system 1 and the sponsor or client entities identified by a GpCode.

As is noted above, announcements or advertisements that are submitted to for posting on the system 1 are reviewed for content acceptable to HipCAd policies. These documents can be submitted in several of the many formats that include pdf, doc, web archive, tiff or one of the many other formats available and are submitted via server 20A.

Sponsor entities may create announcements or advertisements which are to be seen by patients. These parties may simply request that a coupon for drug A be presented to all patients diagnosed with disease B. As general personal information could be obtained based on coupon usage, a patient would be warned before printing or using the offer.

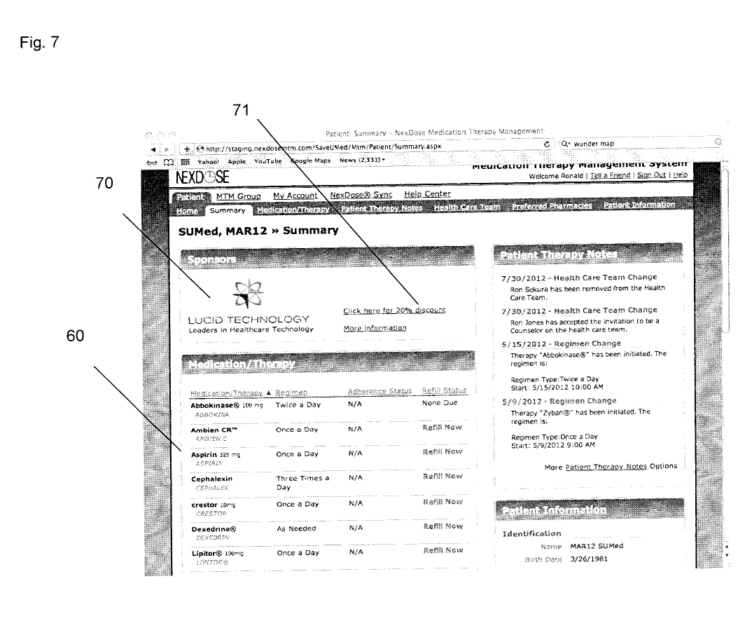

Sponsor entities may have the option to have a banner display 70, as shown in FIG. 7. This Banner display will provide name recognition for the sponsor and will have clickable links through which the sponsor may provide special information or opportunities to the patient or patient health care provider. An example of this type of Banner Display is shown as 70 in FIG. 7.

As part of the submission, information may be collected that defines the criteria (as described above) regarding to which patients the information will be disseminated. Additional information is collected identifying the provider and whether the provider has a GpCode. The submission postings are be submitted to server 20A as one or two parts. The first part is a short announcement that describes the nature of the offer or announcement. For instance, in FIG. 7, this part is posted as an opportunity 71 in the banner which is associated with the individual patient record. In certain instances, the first part provides adequate space to describe the opportunity. The individual opportunities have an embedded link that takes the patient or other authorized party to a more extensive document housed on the secure server 20B which is the second part.

Each of the first and second parts has an associated identifier. Further options include printing the document (e.g. printing the coupon) or a portion of the document and proceeding, via an additional link, to web address outside the server 20B. The patient will be warned that the link may not be secure. In other words, notification is provided and the transfer can be accomplished only with consent. As noted above, each of these displays of material, traffic between links and printing of materials is counted and tracked using specific identifiers.

Depending on the client and the business arrangement for the sponsor or other client entity, billing may be accomplished by direct review of the data generated by the counters. Alternatively, clients can authorize charging a credit card or other financial vehicle to a given dollar value and when this limit is reached, the posting is inactivated unless additional funds are provided. Alerts of the impending depletion of funds are accomplished by e-mail, text message, phone call or other method agreed upon buy the parties.

Materials are posted on the patients opportunity list 50 as a result of the selection processes described above or via a generalized selection process performed automatically by the system in response to requested criteria. The opportunity list 50 provides the opportunities as the first part as described above. The opportunity list 50 is configured in a fashion similar to an e-mail inbox. Postings are arranged chronologically with options for forward or reverse chronology. The patient or other authorized viewer has ability to search the list using a search tool in order to seek specific opportunities.

The user has the option to view the posting, to delete the posting, to click the link embedded in the posting, or mark the posting as read. Postings will become inactive when administrative considerations demand. Viewing of the detailed posting is accomplished by clicking the link with in the posting, for example. This second part, which is enabled by the link, includes the capacity to print materials as appropriate or link to external sites as authorized by the viewer.

When materials are posted to a patient's opportunity list 50, alerts are provided to the patient under mutually agreed upon terms and methods. The methods may include e-mails, text messages, or other communications media. The alerts do not contain any information that reveals confidential information. The alert simply informs the patient that there is information of interest or value posted on his opportunity list 50, see for example the email shown in Table A. The frequency of alerts sent is modulated so as not to cause excessive flow of notices that might be bothersome.

Specialized configuration of the system is performed to accommodate the requirements for clients with adequate patient base to merit the enhancement. For example:
A GpCode might be associated with a organization whose individuals breath nitrogen rather than oxygen. For example, by agreement, a banner would be placed at the top of the page saying: “The American Association of Nitrogen Breathers is here for times you feel distress. Call 888-NITROGN for help.”
Another alternative is an affiliation with a Pharmacy. In addition to providing a banner, the opportunity list 50 may be configured to provide patients with alerts by agreed upon methods (i.e. e-mail, text message, etc,) when it is time for patients to refill prescriptions.
Another alternative is an affiliation with a wellness program or payer, which is focused on patient adherence to medication therapy. In this example, refills or level of adherence tracked by a monitoring device are used as a metric to provide incentives to the patient. These incentive awards are posted on the opportunity list 50 or are provided directly to the patient.

Each of these specialized configurations is tracked by approaches as described above. The system 1 provides service information, and opportunities for patients, care and service providers and advertisers. Voluntary participation in the program, which is secured by firewalls, encryption, and passwords, gives the patient the opportunity to receive confidential information that is secure. The program as structured can provide a service to the patient at nominal cost or even free. Service providers have the option of providing this service to patients for free, the patients being charged only a nominal cost or even no fee at all. Advertisers are given the opportunity to provide promotions to groups of patients (and even to participating medical providers participating in the system) that are very precisely defined. These advertisements can be provided at low cost giving the advertiser a cost effective vehicle for delivering messages to targeted populations.

The site provided by the server 20B may also include a prescription refill algorithm to encourage patients to refill and renew their prescriptions. This sub-system acts as a inducement to encourage pharmacies and others to offer the present system's 1 services to their patients thus providing themselves with an advantage while at the same time expanding the distribution of the present system's 1 services. The refill sub-system may also serve as a revenue source where pharmacies and others pay fees for patients to receive reminders to refill or renew prescriptions for medications. The basis for this revenue stream can be derived by monitoring the frequency at which patients use the system for refill and or the duration covered by patients use therapies alerted by the system.

The refill sub-system encourages, reminds and/or monitors renewal and refills of prescription medications. Emerging requirements in government and other health care payers are establishing pay for performance and other accountability measures which include action for patients to take medication properly. The present prescription refill and renew system supports these requirements.

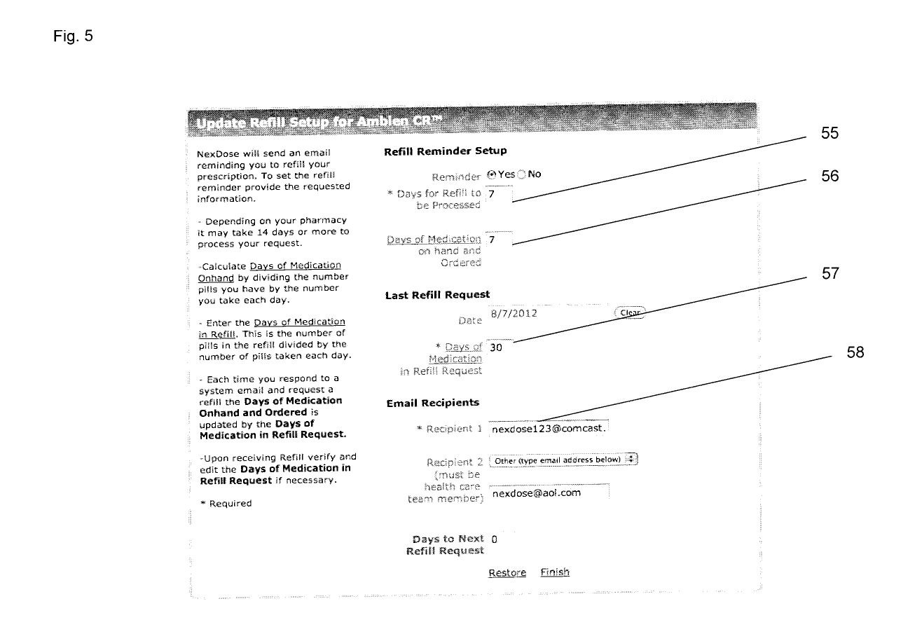

The refill sub-system includes a number of features including an algorithm to calculate when patients or others involved in their health care should be alerted about refills or renewals. FIG. 5 illustrates a refill setup screen which is accessed by selection of medication/therapy option link 51 shown in FIG. 3.

The system parameters are illustrated in FIG. 5 which shows the settings which are able to be set by the patient or health care provider. For example, the patient is able to set the days for a refill to be processed 55 and the days of medication on hand 56. The patient is also able to set email addresses 58 and days of medication in the refill request. This information in elements 55-57 can be automatically populated by information received by the system 1 from a pharmacy.

When an alert is calculated, an e-mail or other notification is sent to the patient or other responsible party alerting them about the refill/renew. This email simply notifies the party about a pending alert. Secured login into the system 1 is required to see specifically what medication or other therapy is due.

FIG. 7 shows an additional embodiment in which refill status and medical refill actions are accessible to the patient. These features can be incorporated in the main summary tab or added as an additional tab to the main screen shown in FIG. 3 which illustrates the adherence status.

Upon login, the responsible party is presented with a list of alerts 60 and has the ability to direct the refill or renewal request to the provider of choice. Both FIGS. 3 and 7 illustrate the list of alerts. In FIG. 7, there is illustrated the main website interface, which is also shown in FIG. 3, with the addition of refill status. The responsible party provides information about method for delivery and other parameters and activates a sequence that sends a message to the provider of choice to fulfill the request.

The provider of choice receives by email or by other means the refill request and acts upon the request. The provider then activates a link that sends a notification to the responsible party or parties that the request has been processed and provides parameters that describe fulfillment of the request.

As an alternative approach, when an email is sent to the patient, the email contains a link to a secure document containing details of the refill notification. After login, the patient reviews the refill notification and is able to click on a link that facilitates an email notification to the pharmacy instructing the pharmacy to process the refill. The pharmacy then clicks a link in this document to inform the patient that the refill is being processed and providing information about the mode of delivery or pickup and the date that the refill will be ready. Refill requests may be pre-populated with pharmacy information and, in instances where a pharmacy is a sponsor, preference is given to populating the refill request data fields with the sponsor pharmacy information.

In the processes described above, the patient record is updated so as to properly provide alerts when the next refill/renewal is due.

Pharmacies or other organizations working to provide service in the scope of these parameters may be a sponsor pharmacy, a participating pharmacy, or a sponsor, for example.

With regard to the sponsor pharmacy, a sponsor code identifies a specific pharmacy. Patients by entering the sponsor code, are linked to the pharmacy. Linkage includes ability to post banners and banner items and access to the patient record by pharmacy staff. Level One access is equivalent to a current health care team counselor. Level Two access is equivalent to current health care team viewer. Level Three access is only permitted to process refill requests. In addition, Level One and Level Two also allow processing of refill requests.

With regard to the participating pharmacy, this is a pharmacy which purchases annual membership as a participating pharmacy. There is a code associated with pharmacies that register as participating pharmacies. Patients are linked to a participating pharmacy by selecting from list of participating pharmacies. A participating pharmacy has only Level Three access.

With regard to the sponsor. This entity can be any person or organization for which desires patient name recognition and desires the opportunity to provide information or offers to the patient and the patient's health care providers. A Sponsor Code could be assigned which identifies a specific sponsor. Patients by entering the sponsor code are linked to the sponsor. Linkage includes the ability for the sponsor to make banner posts and add banner items. The linkage also allows the sponsor to alert the patient with special information or offers.

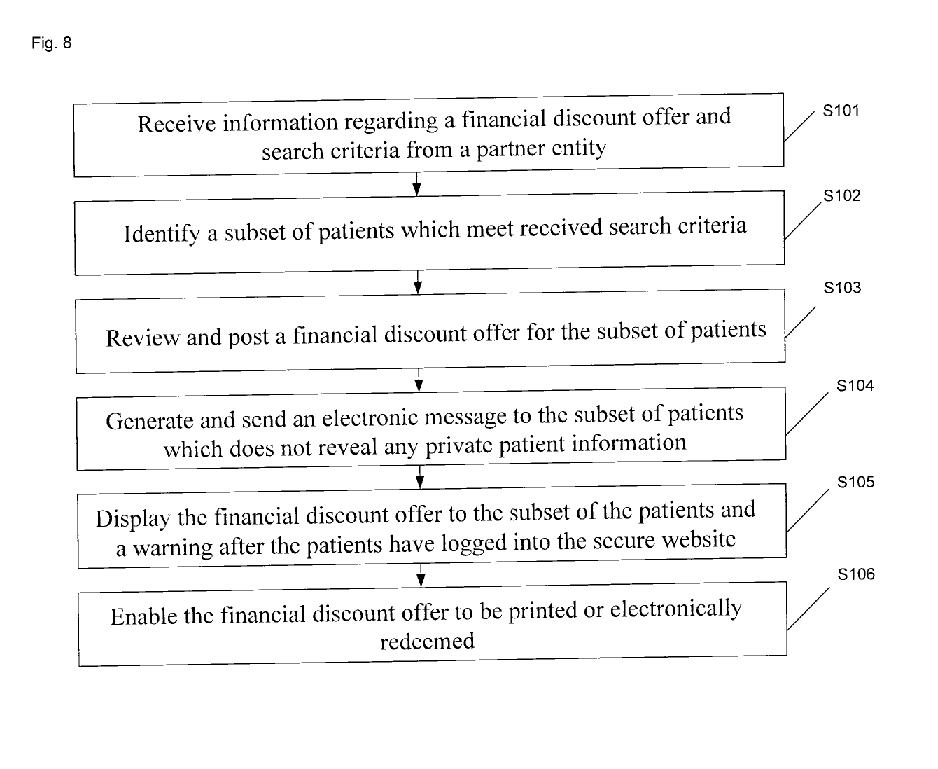

FIG. 8 illustrates a method according to one embodiment of the invention. The method described herein may be performed using a particular machine such as a computer. In this figure, the method is described with a financial discount offer being provided by the medical provider. However, the financial discount offer could be replaced with a message, information, or with a financial incentive or reward, with a new drugs which be of benefit, new studies applicable to the patient, or any information which would be useful or beneficial to the patient.

In step S101 of this embodiment, information regarding a financial discount offer and search criteria (target audience criteria) is received from a client entity at server 20A. The client entity has no access to patient information, patient lists or searches. However, the client entity can provide the system 1 with financial discount, rewards, coupons, etc along with a particular target audience (e.g. patients under 40).

In step S102 a subset of patients are identified which meet the received search criteria by searching the medical records of the plurality of patients without disclosing any medical information to the client entity which submitted the target audience criteria. This searching is performed independently of the client entity and none of the results of this search are shared or are accessible by the client entity. In addition, this search is performed based on the received search criteria in order to identify those patients which are the intended audience of the offer. This search can be performed automatically or manually by an administrator of the system 1.

In step S103, the financial discount offer is processed. This processing can be performed by reviewing and posting the offer for the subset of patients which are identified in the search step S102. The review looks over the information provided by the client entity regarding the offer, coupon, etc. and the subset of patients which result from the search of step S102. Once the review is complete the administrator creates a posting on the individual opportunity list 50 of each user of the subset as well as creates a corresponding detail page for the opportunity. The review and the posting can be performed automatically based on an algorithm which identifies errors and abuse of the system. In addition, the system can work such that only certain client entities require manual review, etc.

In step S104, an electronic message is generated and sent to the subset of patients identified by the identifying in step S102. The electronic message notifies the subset of patients that an offer exists and is accessible via the website, without specifically identifying the financial discount offer.

In step S105, the financial discount offer is displayed to each of the subset of the patients which logs into the website. In addition to the display of the offer, a warning indicating that, by using financial discount offer, private information may be disclosed, is also displayed. This feature enables the patients to use the offer without the system violating regulations.

In step S106, the financial discount offer is enabled to be printed or electronically redeemed in response to a selection on the website.

Features of the invention can be implemented using some form of computer processor. As one of ordinary skill in the art would recognize, the computer processor can be implemented as discrete logic gates, as an Application Specific Integrated Circuit (ASIC), a Field Programmable Gate Array (FPGA) or other Complex Programmable Logic Device (CPLD). An FPGA or CPLD implementation may be coded in VHDL, Verilog or any other hardware description language and the code may be stored in an electronic memory directly within the FPGA or CPLD, or as a separate electronic memory. Further, the electronic memory may be non-volatile, such as ROM, EPROM, EEPROM or FLASH memory. The electronic memory may also be volatile, such as static or dynamic RAM, and a processor, such as a microcontroller or microprocessor, may be provided to manage the electronic memory as well as the interaction between the FPGA or CPLD and the electronic memory. Alternatively, the computer processor may execute a computer program including a set of computer-readable instructions that perform the functions described herein, the program being stored in any of the above-described non-transitory electronic memories and/or a hard disk drive, CD, DVD, FLASH drive or any other known storage media. Further, the computer-readable instructions may be provided as a utility application, background daemon, or component of an operating system, or combination thereof, executing in conjunction with a processor, such as an ARM processor from ARM Holdings, a Xenon processor from Intel of America or an Opteron processor from AMD of America and an operating system, such as Microsoft WINDOWS, UNIX, Solaris, LINUX, Apple, MAC-OSX, Android, iOS, webOS, Windows Phone, and other operating systems known to those skilled in the art.

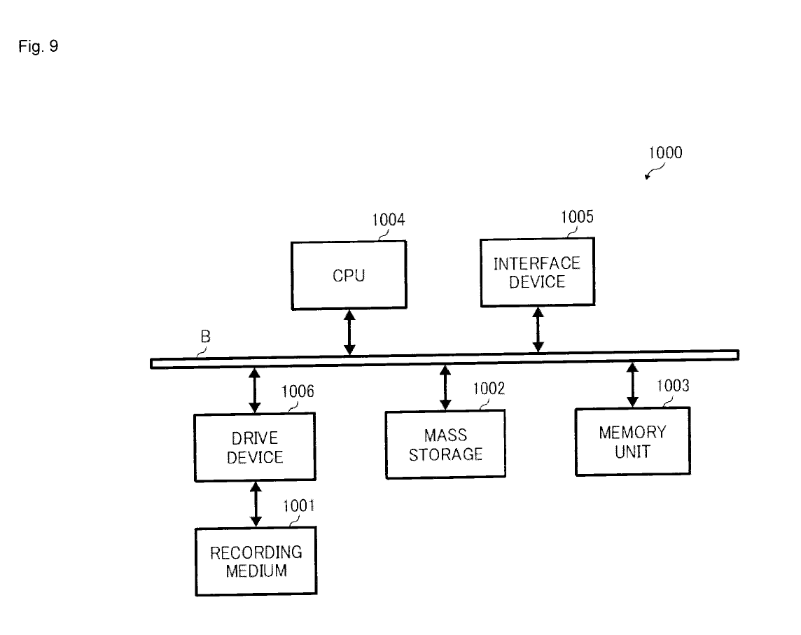

In addition, the invention can be implemented using a computer based system 1000 shown in FIG. 9. The computer 1000 includes a bus B or other communication mechanism for communicating information, and a processor/CPU 1004 coupled with the bus B for processing the information. The computer 1000 also includes a main memory/memory unit 1003, such as a random access memory (RAM) or other dynamic storage device (e.g., dynamic RAM (DRAM), static RAM (SRAM), and synchronous DRAM (SDRAM)), coupled to the bus B for storing information and instructions to be executed by processor/CPU 1004. In addition, the memory unit 1003 may be used for storing temporary variables or other intermediate information during the execution of instructions by the CPU 1004. The computer 1000 may also further include a read only memory (ROM) or other static storage device (e.g., programmable ROM (PROM), erasable PROM (EPROM), and electrically erasable PROM (EEPROM)) coupled to the bus B for storing static information and instructions for the CPU 1004.

The computer 1000 may also include a disk controller coupled to the bus B to control one or more storage devices for storing information and instructions, such as mass storage 1002, and drive device 1006 (e.g., floppy disk drive, read-only compact disc drive, read/write compact disc drive, compact disc jukebox, tape drive, and removable magneto-optical drive). The storage devices may be added to the computer 1000 using an appropriate device interface (e.g., small computer system interface (SCSI), integrated device electronics (IDE), enhanced-IDE (E-IDE), direct memory access (DMA), or ultra-DMA).

The computer 1000 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer 1000 may also include a display controller coupled to the bus B to control a display, such as a cathode ray tube (CRT), for displaying information to a computer user. The computer system includes input devices, such as a keyboard and a pointing device, for interacting with a computer user and providing information to the processor. The pointing device, for example, may be a mouse, a trackball, or a pointing stick for communicating direction information and command selections to the processor and for controlling cursor movement on the display. In addition, a printer may provide printed listings of data stored and/or generated by the computer system.

The computer 1000 performs at least a portion of the processing steps of the invention in response to the CPU 1004 executing one or more sequences of one or more instructions contained in a memory, such as the memory unit 1003. Such instructions may be read into the memory unit from another computer readable medium, such as the mass storage 1002 or a removable media 1001. One or more processors in a multi-processing arrangement may also be employed to execute the sequences of instructions contained in memory unit 1003. In alternative embodiments, hard-wired circuitry may be used in place of or in combination with software instructions. Thus, embodiments are not limited to any specific combination of hardware circuitry and software.

As stated above, the computer 1000 includes at least one computer readable medium 1001 or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other medium from which a computer can read. Stored on any one or on a combination of computer readable media, the present invention includes software for controlling the main processing unit, for driving a device or devices for implementing the invention, and for enabling the main processing unit to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code elements on the medium of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the CPU 1004 for execution. A computer readable medium may take many forms, including but not limited to, non-volatile media, and volatile media. Non-volatile media includes, for example, optical, magnetic disks, and magneto-optical disks, such as the mass storage 1002 or the removable media 1001. Volatile media includes dynamic memory, such as the memory unit 1003.

Various forms of computer readable media may be involved in carrying out one or more sequences of one or more instructions to the CPU 1004 for execution. For example, the instructions may initially be carried on a magnetic disk of a remote computer. An input coupled to the bus B can receive the data and place the data on the bus B. The bus B carries the data to the memory unit 1003, from which the CPU 1004 retrieves and executes the instructions. The instructions received by the memory unit 1003 may optionally be stored on mass storage 1002 either before or after execution by the CPU 1004.

The computer 1000 also includes a communication interface 1005 coupled to the bus B. The communication interface 1004 provides a two-way data communication coupling to a network that is connected to, for example, a local area network (LAN), or to another communications network such as the Internet. For example, the communication interface 1005 may be a network interface card to attach to any packet switched LAN. As another example, the communication interface 1005 may be an asymmetrical digital subscriber line (ADSL) card, an integrated services digital network (ISDN) card, a wireless interface or a modem to provide a data communication connection to a corresponding type of communications line. Wireless links may also be implemented. In any such implementation, the communication interface 1005 sends and receives electrical, electromagnetic or optical signals that carry digital data streams representing various types of information.

The network typically provides data communication through one or more networks to other data devices. For example, the network may provide a connection to another computer through a local network (e.g., a LAN) or through equipment operated by a service provider, which provides communication services through a communications network. The local network and the communications network use, for example, electrical, electromagnetic, or optical signals that carry digital data streams, and the associated physical layer (e.g., CAT 5 cable, coaxial cable, optical fiber, etc). Moreover, the network may provide a connection to, and the computer 1000 may be, a mobile device such as a personal digital assistant (PDA) laptop computer, or cellular telephone.

While certain embodiments have been described, these embodiments have been presented by way of example only, and are not intended to limit the scope of the inventions. Indeed the novel methods and systems described herein may be embodied in a variety of other forms; furthermore, various omissions, substitutions, and changes in the form of the methods and systems described herein may be made without departing from the spirit of the inventions. The accompanying claims and their equivalents are intended to cover such forms or modifications as would fall within the scope and spirit of the inventions.

The present invention is not limited to the specifically disclosed embodiments, and variations and modifications may be made without departing from the scope of the present invention.

1. A method for providing HIPAA and HITECH compliant targeted advertising to patients using a computer having a microprocessor, comprising:
receiving information for posting and target audience criteria from a client entity;
identifying, using the microprocessor and without disclosing any medical information to the client entity, a subset of patients which meet the received target audience criteria by searching medical records of the plurality of patients;
processing the information for the subset of patients identified by the identifying;
generating and sending an electronic message to the subset of patients identified by the identifying, which notifies the subset of patients that an opportunity exists and is accessible via a website, without specifically identifying the opportunity and in response to the completion of the processing;
displaying a portion of the information to each of the subset of the patients which logs into the website; and
enabling a second portion of the information to be accessed in response to a selection on the website.

2. The method according to claim 1, wherein the portion of the information is a financial discount offer.

3. The method according to claim 1, wherein the second portion of the information is accessed via printing or electronic redemption.

4. The method according to claim 1, wherein the second portion of the information is a coupon.

5. The method according to claim 1, wherein the second portion of the information is accessed by further display of the second portion of the information.

6. The method according to claim 1, wherein the second portion of the information is accessed by selection of a link to an external site.

7. The method according to claim 6, wherein, in response to the selection of the link to the external site, a warning is provided indicating that by accessing the external site, privacy may be compromised.

8. The method according to claim 3, wherein the accessing further comprises displaying a warning indicating that by using the second portion of the information, privacy my be compromised.

9. The method according to claim 3, wherein the processing includes reviewing and posting the information for the subset of patients identified by the identifying.
